(19) United States
(12) Patent Application Publication
(10) Pub. No.: US 2002/0064749 A1
(43) Pub. Date: May 30, 2002

(54) Modular colour key, dental kit, reference element and method for colour selection

(76) Inventors: Dietschi Didler, Bernex (CH); Lampl Stephan, Luchingen (CH)

Correspondence Address: SHOEMAKER AND MATTARE, LTD., Crystal Plaza Building 1 - Suite 1203, 2001 Jefferson Davis Highway, Arilington, VA, 22202, US

(21) Appl. No.: 09/968,770

(22) Filed: Oct. 3, 2001

(30) Foreign Application Priority Data
Nov. 28, 2000 (EP) 00811130.4

(51) Int. Cl. A61C 19/10

(52) U.S. Cl. 433/26

(57) ABSTRACT

A colour key system for the colour selection for dental restoration masses or artifical teeth comprises reference elements whose reference region may be modularly constructed by the user. A particularly simple handling for the user results when the reference region of the reference elements are constructed in two parts of a core part and a casing part. Such a two-part system following the natural tooth construction gives a large reproduction certainty and excellent aesthetic results.

The invention relates to a colour key, as an aid to the colour selection, preferably of dental restoration masses or artificial teeth as well as to a dental kit, to a reference element and to a method for selecting the colour, in particular of dental restoring masses or artificial teeth.

Teeth are built up of three differing layers of tissues. In the innermost is the pulp, a blood-circulated, red nerve tissue which for the colour a tooth may play a certain part, but for restoration technology is of minor importance. In the middle there is located the dentin, a soft viscoplastic, opaque mass of a yellow to reddish-brown colour. The outer side of the tooth is formed by enamel, a hard, brittle mass with a high transluscence and a low intrinsic colour in yellow-grey-white tones.

Common tooth fillings or other dental masses replace a part of the dentin and a part of the enamel. The colour and transluscence of the dental masses are therefore selected such that they contain colour components of both tissues and ideally come as close as possible to the picture of appearence of their colour surroundings. So that the dentist knows which colours he must combine with one another for an aesthetically satisfactory result, he requires the help of a colour key.

Such colour keys are known from the state of the art.

Thus DE 198 51 134 shows a colour key with a multitude of insert elements which are insertable into an insert base. The insert elements contain a shank and a colour sample placed thereon. The colour sample is of one piece and consists of the same materials which are used for the restoration. The sample elements have a natural-tooth-like textured front side and a planar, smooth rear side. By way of a joint between the sample element and the shank, a pivoting of the sample element is possible, which permits an improved colour comparison with the patient.

By way of the premanufactured sample elements with a one-piece construction according to DE 198 51 134, a sample element for every conceivable combination of starting material must be made available to the user, which leads to a large number of insert elements and a correspondingly difficult handling of the colour key. Reversely a limitation of the number of insert elements leads to a quality loss with regard to the trueness of colour, the reproduction certainty and the aesthetic result given.

DE 195 09 830 shows a colour key with insert pockets into which colour pins with colour surfaces attached at one end are insertable. As many as possible insert pockets of any number of colour pins may be put together modularly. This allows the user an individual categorisation of any number of colour pins according to any colour designation key used by him. With regard to forming the colour surfaces of the colour pins there are no details.

The modular formation of the insert pockets is in particular directed to the storage and categorisation of a multitude of colour pins. The colour key according to DE 195 09 830 permits no combination of individual colour surfaces. Accordingly the number of the required colour pins is high and the handling with the colour selection is difficult.

U.S. Pat. No. 5,743,730 shows a colour information system designed for dental laboratories, in particular for application with prostheses based on porcelain. The colour information system consists of a base sheet with may be superimposed with further, preferably four neutral sheets. Onto the neutral sheets with the help of colour sticks there may be deposited reference colour surfaces. With this there arises a layered build-up of the reference which allows the dental technician a layered retro-working with the manufacture of tooth prostheses.

A disadvantage of the colour system according to U.S. Pat. No. 5,743,730 lies in the fact that inspite of the superimposing of several layers of leaves, the optical effect of the resulting reference differs from the effect of real teeth. Factors such as light diffraction, transluscence, etc. are taken too little into account. Furthermore the reference colours applied with the help of the colour pins do not correspond to the original colours of the dental masses used by the dental technician. The multi-layered reference is furthermore not positionable or is only so difficultly positionable that a direct colour comparison on the set of teeth of the patient is not possible.

It is therefore the object of the invention to avoid the disadvantages of that which is known, in particular to make available a colour key for colour selection which may be handled as simply as possible, in particular for dental restoration masses or artifical teeth, which with as few as possible colour reference elements gives a correct colour impression of the tooth structure, ensures a high reproduction certainty and meets high aesthetic demands. The colour key should also in particular in a simple manner be useable directly on the set of teeth of the patient.

According to the invention this object is achieved with a colour key as well as with a method for colour selection, in particular of dental restoration masses or artificial teeth, according to the features of the characterising part of the independent patent claims.

A colour key, in particular for colour selection of dental restoration masses or artificial teeth comprises a multitude of reference elements, whose reference region is modularly constructable of at least two parts.

Modularly constructable in the context of the invention is with this to be understood in that the reference elements during the colour selection may be joined together of at least two parts by the user. At the same time at least the reference region of the reference elements are modularly constructable of at least two parts. It is however also conceivable for the whole reference element to be modularly constructable. As a reference region within the context of the invention one indicates the region of the reference element which has the reference colour for the colour selection. The modularly constructed reference regions of the reference elements in the colour keys according to the invention have in every case a three-dimensional spacial extension. In particular the parts used for the modular construction of the reference regions of the reference elements comprise edges and/or curvatures. As a whole the parts used with the modular construction contribute to the formation of a voluminous body in the reference region. This is particularly important with regard to the colour trueness, since at the same time also effects such as light diffraction, transluscence etc., may be able to be sufficiently taken into account.

Since the user has the possibility himself of modularly constructing the reference region by way of combination of at least two parts, it may be avoided in the colour key already that all combinations of the colour materials need be made available as individual reference elements. By way of a suitable choice of the colours of the parts for the modular construction of the reference region thus with few basic elements there may be obtained a colour key which gives satisfactory results with respect to reproduction certainty and aesthetic demands over a large colour range. The number of reference elements may be reduced by way of this, by which means the handling ability of the colour key is simplified and the requirement for the whole system is in total minimised.

The colour key according to the invention may in particular be used for the colour selection of dental restoration masses or artificial teeth. The application of the colour key according to the invention is however conceivable whenever materials, e.g. in the dental region, are to be added to an already present colour environment. To these there for example belongs also inlays, on-lays, crowns, bridges, etc.

A particularly simple handling of the colour key is achieved when the reference region of the reference elements is modularly constructable in two parts, of a core part and of a casing part.

Surprisingly it has been shown that a two-part modular construction of the reference region of the reference elements is sufficient in order to give results which meet the highest demands of colour trueness and aesthetics. Such a two-part construction reflects in the simplest manner the previously mentioned tooth construction. The core part at the same time advantageously contains various colour tones, as they are found in the natural dentin tissue, in any case depending on the age of the patient. Analogous to this the casing part may contain various colour graduations as they occur in the outer tooth layer, the enamel.

The casing part at the same time as with enamel has a good transluscence so that the core part shines through the casing part. The resulting colour combination of the core and casing part in the reference region thus for the user by way of the interaction of the core and casing part results in a realistic colour impression, which reflects the interaction of the dentin and enamel of the tooth.

In a preferred optimised embodiment example the colour key comprises six casing parts and seven core parts. Such a standard colour key has only a small space requirement and the handling is considerably simplified compared with colour keys of the state of the art.

Advantageously the core part and casing part of the reference element are designed such that they may be joined together with a positive fit. At the same time it is conceivable for the core part to be brought into the casing part. This may for example be effected by inserting the core part into a hollow space of the casing part. Alternatively it is however also conceivable to arrange the casing part outside on the core part for example by way of pulling-over or sticking-on, etc.

The positive-fit formation of the core part and the casing part prevent larger air inclusions with the modular construction which could lead to undesired light diffraction. In order to prevent any interfering effects before the joining together of the core part and casing part, in the known manner a glycerine solution may be brought into any intermediate spaces which however occur.

For the modular construction of the reference region of the reference element, as also with the procedure for the colour selction, it is advantageous when at least the core part or the casing part comprise a holding element via which the user may fix the reference element with his fingers.

In a particularly preferred embodiment example the core parts as well as the casing parts in each case have a holding element, in particular a stem, wherein the two holding elements of a core and casing part may be joined together. By way of this a particularly good handling of the core parts as well as casing parts is ensured. This is of particular importance when the two holding elements of the core and casing part may be joined together. By way of this it is achieved that not only the reference region consisting of the core and casing part, but also the holding region of the reference element is modularly constructed, which as a whole contributes to the mechanical stability of the reference element.

In a particularly preferred embodiment example the holding elements of the core and casing parts comprise aids with which the core and casing part are mutually alignable. For the reproduction certainty of the colour key it is important that the modularly constructed reference elements, in particular the reference region, has a reproducable arrangement independent of the selection of the corresponding core and casing parts. This is achieved in that the core and casing part are mutually alignable, in particular such that they are positively fitting in the modularly constructed reference element.

This is achieved particularly simply when the core and casing part are bringable from a first contact position into an end position. This is achieved particularly simply when a holding element comprises a groove into which the other holding element of the other part is introduced and displaceably mounted.

It is particularly advantageous for the colour trueness and the reproduction certainty when the core and casing part consist of dental masses, in particular the original materials used when filling cavities or with the construction of artificial teeth. It is particularly advantageous for the user when there is made available to him a dental kit which contains materials for the dental restoration as well as a colour key according to the invention with reference elements modularly constructed of the above mentioned materials. Of course the dental kit may contain further components such as primers, etching gel, polishing paste etc., which are usually required with the restoration.

In a preferred embodiment example of the colour key the holding element or elements for the core and or the casing part are formed of a transparent material. With this it is achieved that the holding elements do not negatively compromise the colour impression which the user obtains from the reference region of the reference elements. Ideally the used plastic is furthermore solvent-resistant so that in particular the commonly employed disinfectants do not lead to an opaqueness or other negative impairement of the holding elements. Preferred plastics are e.g. polyamides, polycarbonates, polymethyl acrylates, etc. Of course it is also conceivable for less demanding applications of the colour key to apply non-transparent plastics.

If the modularly constructed reference region of the reference elements has essentially the shape of a tooth, factors such as transluscence, reflections or differing layer thicknesses of enamel and dentin are taken into account particularly well, which in particular has a favourable effect on the reproduction certainty and colour trueness, since by way of this with the eye it is possible to compare on an equal footing. Of course for less demanding fields of application and applications there are also conceivable reference elements which have a schematised reference region, e.g. in the shape of a cuboid or a hemisphere. In any case the modularly constructed reference regions of the reference elements in the colour keys according to the invention however have a three-dimensional spacial extension.

An optimal handling for the user is achieved when the colour key comprises at least one base plate in which the reference elements are insertable. In a particularly preferred embodiment example the colour key comprises a first base plate into which the core parts with their holding elements are insertable and a second base plate into which the casing parts via their holding elements are insertable, so that the core and casing parts are separately storable.

A further subject-matter of the invention is a method for the colour selection in the dental field with a colour key with reference elements which are modularly constructable of core and casing parts.

The method according to the invention allows the user before putting together the reference elements to make a separate pre-selection for the core and the casing part.

In a step a) various core parts are positioned at a first location, in particular on a dental root, until there is achieved a coloured matching with the reference object, in particular the dentin of the patient.

In a step b) which may be carried out before or after step a), various casing parts are positioned at a second location different from the first location, until there is achieved a coloured matching with the reference object, in particular the enamel of the patient.

In a step c) the core part selected in step a) is modularly constructed with the casing part selected in step b) into a reference element so that the reference element has a modularly constructed reference region which reflects the natural tooth construction of dentin and enamel.

It is particularly advantageous when the reference element constructed in step c) is positioned on a tooth for colour comparison in order to check the colour trueness. The steps a) to d) are ideally repeated for so long until the colour comparison in step d) leads to an acceptable result.

The method according to the invention with this permits a step-by-step colour comparison of dentin and enamel and a complete assessment by way of the modularly constructed reference elements. At the same time, allocated to the modular parts of the reference elements are in each case unambiguous referencings. To each possible combination of dentin colour (core part) and enamel colour (casing part) in this manner there may be allocated an unambiguous dental mass, particularly restoration mass.

The invention is hereinafter described in more detail in embodiment examples and by way of the drawings. These serve exclusively for an improved illustration of individual embodiment forms according to the invention and are in no way to be observed as conclusive. There are shown in:

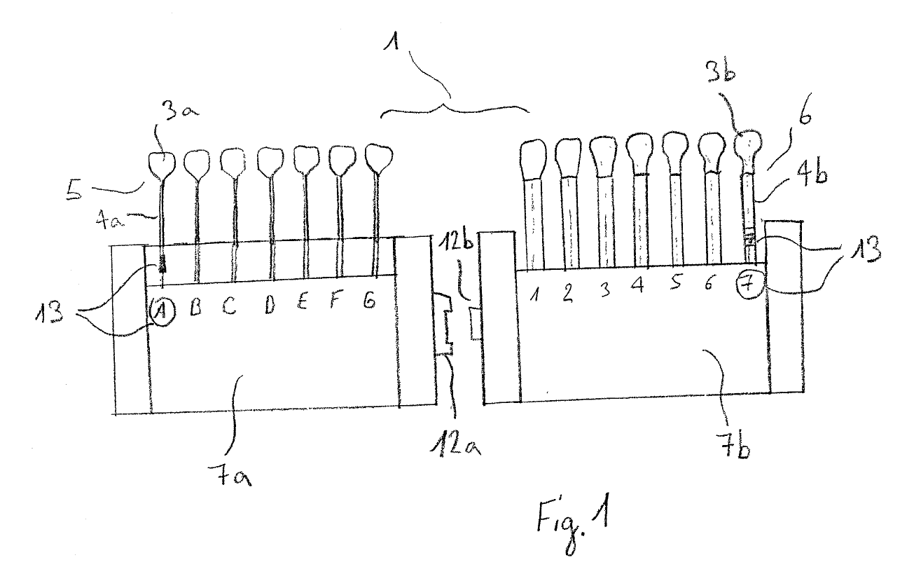

FIG. 1 a preferred embodiment example of a colour key according to the invention;

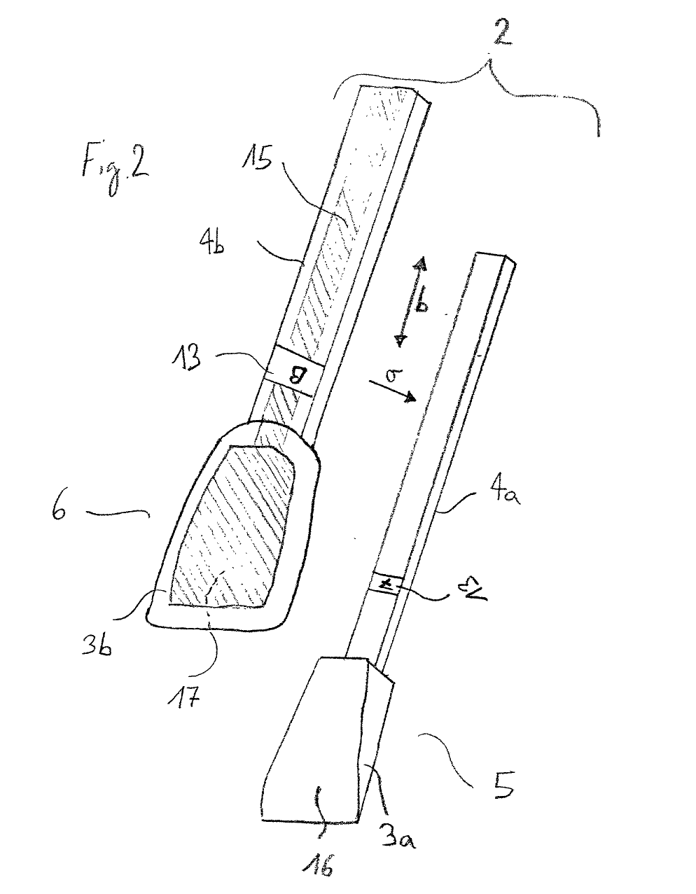

FIG. 2 a perspective representation of a core and casing part of a colour key according to the invention for the modular construction of a reference element and

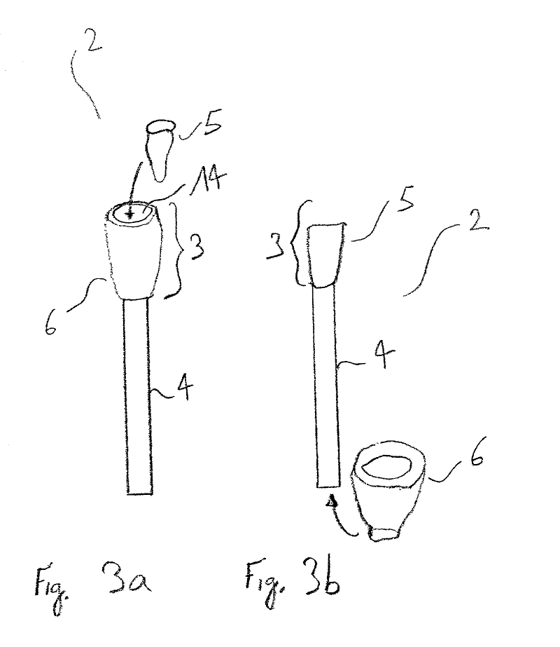

FIGS. 3a/3b selected alternative embodiment examples of reference elements of a colour key according to the invention, whose reference region may be modularly constructed.

FIG. 1 shows a colour key 1 according to the invention. The shown colour key 1 consists of two base plates 7a and 7b. Into the first base plate 7a core parts 5 are inserted via holding elements 4a. The reference region 3a of the core parts 5 consists of dental original material. The individual core parts 5 may be arranged in the base plate 7a according to certain criteria, e.g. by way of the brightness. In order to ensure a reproducable arrangement the base plate 7a as well as the individual core parts 5 may contain an index 13. In a second base plate 7b there are inserted casing parts 6 via the holding elements 4b. The reference region 3b of the casing parts 6 serves for the colour comparison with the outermost tooth layer (enamel). The various casing parts 6 may be graduated according various brightnesses, as they e.g. occur with the patient depending on age. For the reproducable arrangement the casing parts 6 and the base plate 7b may likewise comprise an index 13. It may be particularly advantageous for a good handling of the colour key 1 when both base plates 7a, 7b are connectable via connecting elements 12a and 12b.

FIG. 2 shows a perspective representation of a core part 5 and of a casing part 6 for the modular construction of a reference element 2 of a colour key 1 according to the invention. The core part 5 comprises a holding element 4a, in particular a stem. The reference region 3a of the core part 5 is constructed of dental original masses, as are used with the restoration or layered construction of teeth. A casing part 6 comprises a holding element 4b and a reference region 3b. The reference region 3b is likewise formed of dental original masses. From the core part 5 and the casing part 6 a reference element 2 may be modularly constructed by the user. With this the casing part 6 is arranged over the core part 5 by way of a movement in direction (a), wherein the holding element 4a of the core part 5 comes to lie in a groove 15 of the holding element 4b of the casing part 6. In this so-called contact position the reference region 3b of the casing part 6 contacts the holding element 4a of the core part 5. By way of a relative movement of the core part 5 and the casing part 6 along the longitudinal direction of the holding elements 4a and 4b (arrow direction b) the reference element 2 is brought into its end position, wherein for the longitudinal movement along (b) the groove 15 in the holding element 4b of the casing part 6 serves as a guiding rail. The reference regions 3a, 3b are in each case constructed as three-dimensional bodies. The shape of the outer surface 16 of the reference region 3a of the core part 5 corresponds roughly to the shape of the inner surface 17 of the casing part 6. In the end position the outer surface 16 of the core part 5 as well as the inner surface 17 of the casing part 6 in particular in the reference regions 3a, 3b are joined together with a positive fit.

With the reference element 2 shown here a step-by-step colour comparison of the tooth core (dentin) and enamel as well as a complete assessment is possible by way of the modularly constructed reference elements 2.

In FIG. 3 there are represented two alternative embodiment examples of reference elements 2 of a colour key 1 according to the invention, wherein the reference element 2 comprise modularly constructable reference regions 3. In FIG. 3a there is shown a casing part 6 which comprises a holding element 4 in particular a stem. The casing part 6 which ideally consists of the originally used dental material comprises in its inside a hollow space 14 into which a selected core part 5 may be inserted. The thus arising reference element 2 with a modularly constructed reference region 3 comprises according to FIG. 3a a tooth-like shape. Of course for less complex applications also simpler basic forms of the reference region 3 are conceivable. For example the reference region 3 may be formed as a hemisphere or styled cube.

In FIG. 3b there is shown a core part 5 with a holding element 4. Onto the core part 5 there may be placed on, pulled over, stuck on, etc. a casing part 6. In this manner there likewise results a reference element 2 with a modularly constructed reference region 3.

Of course further forms of modularly constructable reference elements 2 are conceivable. In particular it is also conceivable to construct the reference region 3 of more than two parts.

1. A colour key, in particular for colour selection of dental masses for the restoration of teeth or for the manufacture of artificial teeth, with a plurality of reference elements (2) which comprise a reference region (3) and said reference region (3) being modularly constructed, characterised in that the reference region (3a/3b) of the reference elements (2) is modularly constructable in two parts of a core part (5) and of a casing part (6) and that for imitating the natural tooth construction the core part (5) and the casing part (6) consist of the dental masses.

2. A colour key according to claim 1, characterised in that the casing part (6) has the shape of a tooth.

3. A colour key according to one claim 1, characterised in that the core part (5) and the casing part (6) of the reference element (2) are formed such that they may be joined together with a positive fit.

4. A colour key according to claim 1, characterised in that the core part (5) and the casing part (6) in each case comprise a holding element (4a/4b), in particular a stem, wherein the two holding elements (4a/4b) may be joined together.

5. A colour key according to claim 4, characterised in that the holding elements (4a/4b) comprise aids, with which the core part (5) and the casing part (4) are mutually alignable.

6. A colour key according to claim 5, characterised in that the aids are formed such that the core part (5) and the casing part (6) are bringable from a first contact position into an end position.

7. A colour key according to claim 5, characterised in that the holding elements (4a/4b) are formed of a transparent plastic.

8. A colour key according to claim 1, characterised in that the modularly constructed reference region (3) of the reference elements (2) is formed in the manner of a natural tooth, in particular in roughly the shape of a tooth.

9. A colour key according to claim 1, characterised in that the colour key (1) comprises at least one base plate (7) into which the reference elements (2) are insertable.

10. A dental kit containing a colour key, in particular a colour key (1) according to claim 1, with reference elements (2) whose reference region (3) is modularly constructable.

11. A reference element with a reference region (3) for a colour key (1) according to claim 1.

12. A method of use of a colour key (1) with reference elements (2) whose reference region (3) is modularly constructable, in particular of a colour key (1) according to claim 1, for the step-by-step colour selection of dental masses corresponding to the natural tooth construction for the restoration of teeth or for manufacturing artifical teeth.

13. A method for the colour selection, in particular in the dental region, with a colour key (1) with reference elements (2) which are modularly constructable of core (5) and casing parts (6), in particular with a colour key (1) according to claim 1, containing the steps (a-c)
a) positioning various core parts (5) at a first location, in particular on a dental root, until a coloured matching between the reference region (3a) of a core part (5) with the location is achieved.
b) positioning various casing parts (6) before or after step a) at a second location different from the first, in particular at a cutting edge of a tooth, until a coloured matching between the reference region (3b) of a casing part (6) with the location is achieved.
c) joining together a core part (5) selected in step a) with a casing part (6) selected in step b) into a reference element (2) with a modularly constructed reference region (3).

14. A method according to claim 13, characterised in that the reference element (2) constructed in step c) is positioned on a tooth for colour comparison in step d).

15. A method according to claim 14, characterised in that the core part (5) selected in step a) and/or the casing part (6) selected in step b) are substituted by another core part (5) and/or casing part (6) for so long until the colour comparison in step d) leads to an acceptable result.
